(19) United States
(12) Patent Application Publication
(10) Pub. No.: US 2007/0235423 A1
(43) Pub. Date: Oct. 11, 2007

(54) PROTECTIVE CASE FOR PLASMA CUTTER

(76) Inventors: Brian J. Bornemann, Menasha, WI (US); Steve D. Hidden, Appleton, WI (US); Don Keddell, Menasha, WI (US); Joseph C. Schneider, Menasha, WI (US)

Correspondence Address: ZIOLKOWSKI PATENT SOLUTIONS GROUP, SC (ITW), 136 S WISCONSIN ST, PORT WASHINGTON, WI, 53074, US

(21) Appl. No.: 11/278,634

(22) Filed: Apr. 4, 2006

(51) Int. Cl. B23K 9/00

(52) U.S. Cl. 219/121.39

(57) ABSTRACT

The present invention is related to a protective case for stowage of a plasma cutter wherein the plasma cutter can be placed into the protective case in the same orientation as it used. The plasma cutter is securely retained within the protective case by formations on the bottom of the case and on the lid that sandwich and hold the plasma cutter therebetween to prevent its movement within the case. The protective case also has provisions for stowing an accessory box and a plug accessory and which are also securely retained to prevent movement within the protective case.

### BACKGROUND OF THE INVENTION

The present invention relates generally to plasma cutting systems, and, more particularly, to a protective case for containing a plasma cutter.

Plasma cutting is a process in which an electric arc is used for cutting or gouging a workpiece. The plasma cutter is generally contained within a housing and provides output power to a pair of cables that extend from the plasma cutter apparatus. One of the cables has a torch that is located at the outer end of the cable and the other cable has a work clamp at its outer end that is adapted to be attached to the workpiece.

The plasma cutter apparatus is designed to be a portable unit, that is, the plasma cutter can be carried by a person from location to location. Basically, the new inverter based plasma cutters now achieve the portability of other industrial power tools. With such portability, however, there is an increased risk of damage to the plasma cutter which increases the importance of protection in transport and storage.

While there are protective cases used among highly portable power tools, such as drills, saws and the like, at the present, protective cases are not widely used with plasma cutters. Protective cases have also been used on portable welding equipment, however, these protective cases for that purpose require manipulation of the power source from a natural vertical position to a horizontal position. In addition, the weld and ground cables for such welding equipment must be detached from the power source and be deliberately arranged in a specific manner into a storage position.

With a plasma cutter, the reorientation of the cutter is made more difficult by the comparative size, weight and amount of cabling that needs to be manipulated, as compared with standard power tools.

Accordingly, it would be advantageous to have a protective case that requires little, if any, cable and power source manipulation in order stow the plasma cutter therein. In addition, it would be advantageous to have a protective case that requires minimal power source and cable manipulation for stowage in the protective case, while closely matching the aspect ratio of the plasma cutter to maximize space efficiency.

### BRIEF DESCRIPTION OF THE INVENTION

Therefore, in accordance with the present invention, there is a protective case for a plasma cutter that allows the plasma cutter to be stowed in the protective case with no manipulation needed to put the plasma cutter into a particular orientation. That is, the plasma cutter is stored in the protective case in the same orientation as it is used. In addition, the aspect ratio i.e. height to width can be nearly equal to the aspect ratio of the plasma cutter itself.

The protective case with the plasma cutter contained therein can be readily carried by a user and the plasma cutter is securely retained within the protective case by being sandwiched between a special formation formed on the inner surface of the lid and the inner surface of the bottom of the case.

There is also space provided for the stowage of an accessory box and plug accessories and those components are also specially securely retained within the protective case so as to prevent their movement therein.

These and other features and advantages of the present invention will become more readily apparent during the following detailed description taken in conjunction with the drawings herein.

### BRIEF DESCRIPTION OF THE DRAWINGS

In the drawings:

FIG. 1 is a perspective view of a protective case for a plasma cutter constructed in accordance with the present invention;

FIG. 2 is an exploded view of the protective case of FIG. 1 illustrating the stowage of a plasma cutter and other components therein;

FIG. 3 is a perspective view of the protective case with a side removed to illustrate the internal chamber of the protective case;

FIG. 4 is a side cross-sectional view of the protective case with the plasma cutter and other components stowed therein;

FIG. 5 is a cross sectional view taken along the line 5-5 of FIG. 4; and

FIG. 6 is a cross sectional view taken along the line 6-6 of FIG. 4.

### DETAILED DESCRIPTION OF THE PREFERRED EMBODIMENT

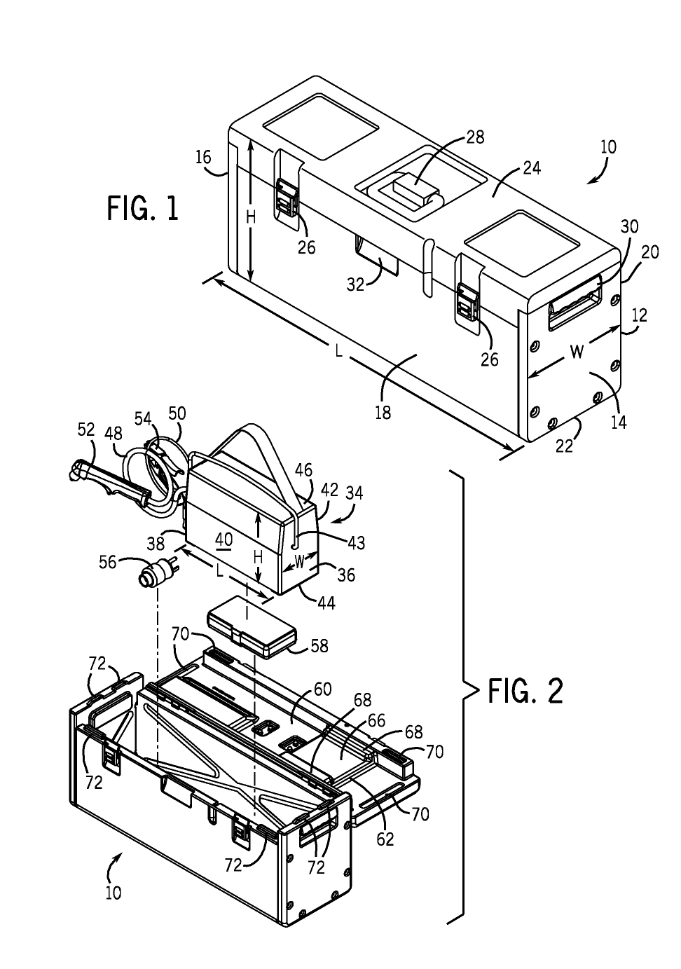

Turning first to FIG. 1, there is shown a perspective view of the protective case 10 constructed in accordance with the present invention. As can be seen, the protective case 10 comprises a base 12 having ends 14, 16, lateral sides 18, 20 and a bottom 22. Atop of the base 12 is a lid 24 that is preferably hingedly affixed to the base 12. The hinge, not shown in FIG. 1, is located between the lid 24 and the lateral side 20 such that the lid 24 can be rotated about the hinge between an open position and the closed position as is illustrated in FIG. 1.

Latches 26 are provided to retain the lid 24 in its closed position and the latches 26 can be conventional latches with complementary, interfitting components on the lid 24 and the lateral side 18, it only being important that the latches 26 be strong enough to enable a user to lift the protective case 10 by means of a carrying handle 28 while containing a plasma cutter along with other components. Additional carrying handles 30 can be provided in the ends 14, 16 of the protective case 10, only one of which is shown in FIG. 1. There may also be an inwardly slanted area 32 to facilitate the user getting a hand grip under the lid 24 to move it to its open position. The dimensions of the protective case 10 are illustrated as the width W, the height H and the length L.

Turning now to FIG. 2, there is shown an exploded view showing the protective case 10 of the present invention and the plasma cutter 34 as well as other components that can be stowed in the protective case 10. As shown, the plasma cutter 34 is generally rectangular in shape having ends 36, 38, sides 40, 42, a bottom 44 and a top 46. The dimensions are illustrated as the width w the height h and the length 1. Extending outwardly from the plasma cutter are a pair of cables, that is, there is a torch cable 48 and a clamp cable 50 with a torch 52 and a clamp 54 located, respectively, at the ends of those cables. A power cord 43 extends from the plasma cutter for connection to a source of power.

There are other components or consumables, used or likely to be used in connection with the operation of the plasma cutter 34 that can be stowed in the protective case 10 and thus be readily available to the user. Such components may include a plug accessory 56 and an accessory box 58 that may contain miscellaneous consumables.

There can also be seen in FIG. 2, an inner lid surface 60 that is the interior surface of the lid 24 and there is a formation 62 formed thereon. The formation 62 comprises a channel 66 having lateral, spaced apart edges 68 that project outwardly from the inner lid surface 60 and the purpose of the formation 62 will be explained later.

There can also be various interlocking or strengthening features used on the overall protective case 10 when the lid 24 is in its closed position, such as a number of recesses 70 formed in the inner lid surface 60 into which interfit a number of elongated projections 72 formed in the upper edge of the base 12.

Thus in FIG. 2 it can also be seen that the plasma cutter 34 is stowed in the protective case 10 in the same orientation that it is used, i.e. the normal bottom 44 of the plasma cutter 34 is located proximate to the bottom 22 of the protective case 10 and, therefore, the plasma cutter 34 need not be manipulated in some manner by the user to an unusual orientation to stow the plasma cutter 34, thereby making the stowage of the plasma cutter 34 relatively easy.

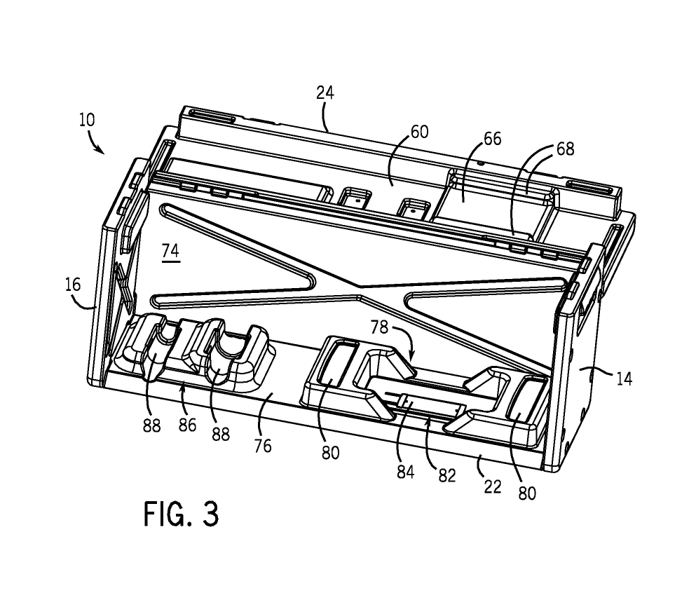

Turning now to FIG. 3 there is shown a perspective view of the protective case 10 with the lateral side 18 removed in order to view the internal chamber 74 within the base 12. Thus, there is an inner bottom surface 76 that is the interior surface of the bottom 22 of the protective case 10.

As can be seen, there is a formation 78 formed on the inner bottom surface 76 in the form of two recesses 80. The recesses 80 are spaced apart a predetermined distance and shaped so as to receive corresponding and mating structures formed on the bottom 44 of the plasma cutter 34 as will later be seen. There is a further formation 82 located intermediate the recesses 80 in the form of a large recess 84 that is sized and shaped to snugly receive and retain the accessory box 58 (FIG. 2) therein so that the accessory box 58 does not move when positioned therein.

A still further formation 86 is formed in the inner bottom surface 76 and is in the shape of two generally cylindrical indentations 88 that are each adapted to receive and retain a plug accessory 56 (FIG. 2) in a snap fit arrangement.

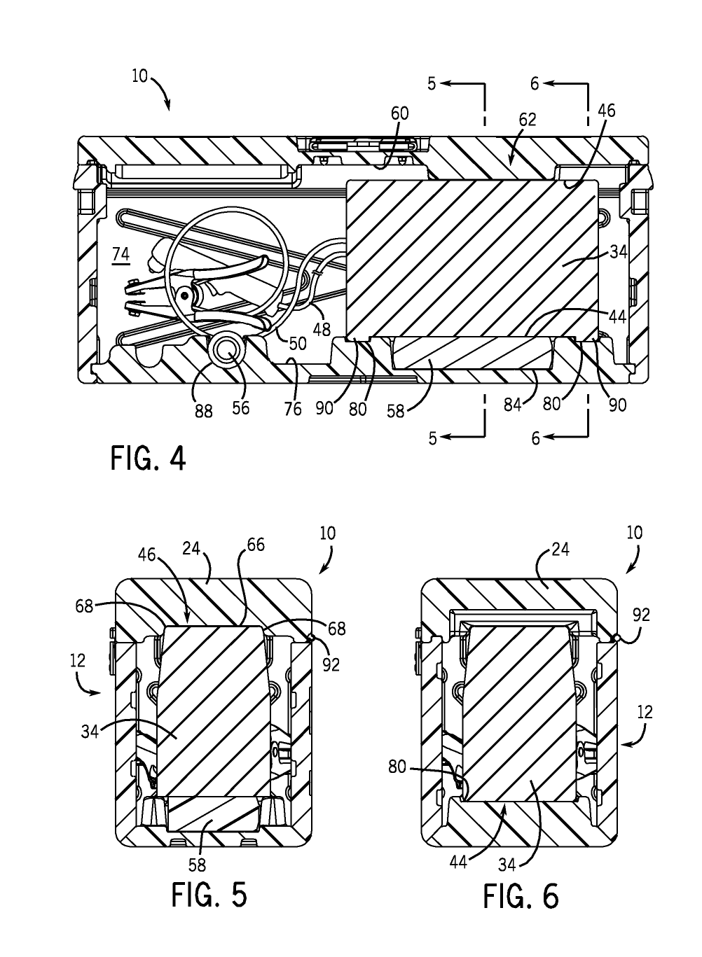

Turning next to FIG. 4, there is shown a side cross sectional view of a protective case 10 having stowed therein a plasma cutter 34, an accessory box 58 and a plug accessory 56. There is sufficient space within the internal chamber 74 to stow each of the torch cable 48, the clamp cable 50, and the power cable (not shown) easily along with the other components. The accessory box 58 is safely and securely retained within the large recess 84 underneath the plasma cutter 34 and the plug accessory 56 is snap fitted into the cylindrical indentation 88 and is also therefore safely secured within the protective case 10.

The plasma cutter 34 is also safely and securely retained within the protective case 10 by means of the interfitting of the projections 90 in the form of feet on the bottom 44 of the plasma cutter 34 into the corresponding shaped recesses 80 in the inner bottom surface 76 of the protective case 10. That interfitting relationship prevents the movement of the plasma cutter 34 across the inner bottom surface 76 of the protective case 10 and the further formation 62 on the inner lid surface 60 bears against the top 46 of the plasma cutter 34 and holds that top 46 to prevent lateral or vertical movement of the plasma cutter 34.

Turning now to FIG. 5, there is a cross sectional view taken along the line 5-5 of FIG. 4 and illustrating the means of securely retaining the plasma cutter 34 within the protective case 10. Accordingly in this view, the hinge 92 can be seen that rotatably affixes the lid 24 to the base 12.

Further in FIG. 5, the accessory box 58 is seen retained underneath the plasma cutter 34 and the plasma cutter 34 itself has its top 46 nested within channel 66 with the edges 68 of the channel 66 extending downward to contact opposite sides of the plasma cutter 34 so that both the accessory box 58 and the plasma cutter 34 are both securely retained within the protective case 10 and are prevented from movement therein.

Finally turning to FIG. 6, there is a cross sectional view taken along the line 6-6 of FIG. 4 and illustrating the bottom 44 of the plasma cutter 34 interfitting into the recess 80 so that the lateral movement of the plasma cutter 34 is prevented.

Returning to FIG. 1, the dimensions are illustrated to show how the present protective case 10 can be effectively dimensioned in order to maximize the space efficiency. Taking FIG. 1, therefore, along with FIG. 2, the length dimension L of the protective case 10 is of sufficient length to allow the stowage of the plasma cutter 34 and the cables. The height H to width W ratio (H:W) i.e. the aspect ratio of the protective case 10 in its normal orientation is nearly equal to the height h to width w ratio (h:w) i.e. the aspect ratio of the plasma cutter 34 in its normal orientation. In addition, the height H of the protective case 10 has sufficiently depth to allow the cables to be stowed by coiling and dropping the cables into the space alongside the plasma cutter 34, thereby eliminating the need to remove the cables and/or specifically secure the cables.

Those skilled in the art will readily recognize numerous adaptations and modifications which can be made to the protective case for a plasma cutter of the present invention which will result in an improved case, yet all of which will fall within the scope and spirit of the present invention as defined in the following claims. Accordingly, the invention is to be limited only by the following claims and their equivalents.

What is claimed is:

1. A protective case for stowing a plasma cutter having cables extending therefrom, the protective case comprising a base having ends, lateral sides and a bottom forming a chamber, a lid affixed to the base having an open and closed position, the lid having an inner lid surface, the base having an inner bottom surface, wherein the inner bottom surface, the inner lid surface, the ends, and the lateral sides are configured to receive and securely retain a plasma cutter therein, the chamber providing a space for stowing cables, and wherein the plasma cutter is retained snugly within the chamber of the protective case.

2. A protective case for stowing a plasma cutter having cables extending therefrom, the protective case comprising a base having ends, lateral sides and a bottom forming a chamber, a lid affixed to the base having an open and closed position, the lid having an inner lid surface, the base having an inner bottom surface having a formation configured to receive and securely retain a plasma cutter, the chamber providing a space for stowing cables, the inner lid surface having a formation configured to contact a plasma cutter when positioned within the protective case, wherein a plasma cutter is sandwichable between the formation formed on the inner lid surface and the formation of the inner bottom surface to hold the plasma cutter from movement within the protective case.

3. The protective case as defined in claim 2 wherein the base has a second formation formed in the inner bottom surface for retaining at least one plug accessory.

4. The protective case as defined in claim 3 wherein the second formation provides a snap fit for the at least one plug accessory.

5. The protective case as defined in claim 2 wherein the formation formed on the inner bottom surface comprises two spaced apart recesses.

6. The protective case as defined in claim 2 wherein the dimensions of the chamber are designed to receive a plasma cutter oriented in its normal operating orientation.

7. The protective case as defined in claim 2 wherein the lid is hinged to move between the open and a closed positions and wherein latches are provided to retain the lid in its closed position.

8. The protective case as defined in claim 2 wherein the base has a third formation formed in the inner bottom surface for stowing an accessory box.

9. The protective case as defined in claim 2 wherein the third formation is a recess located beneath a plasma cutter when positioned within the protective case.

10. The protective case as defined in claim 2 wherein the formation formed on the inner lid surface is a channel that contacts two sides and the top of a plasma cutter when positioned within the protective case.

11. A combination of a protective case enclosing a plasma cutter, the combination comprising:
a protective case forming a chamber, the protective case having a inner bottom surface with a formation formed thereon and a lid having an open and closed position enclosing a chamber, the lid having an inner lid surface having a formation formed therein;
a plasma cutter within the chamber, the plasma cutter having a bottom surface interfitting with the formation on the inner bottom surface to securely retain the plasma cutter within the protective case; and
wherein the formation formed on the inner lid surface interfits with the plasma cutter when the lid is in the closed position to prevent lateral or vertical movement of the plasma cutter by sandwiching the plasma cutter between the formation on the inner lid surface and the formation on the inner bottom surface of the protective case.

12. The combination of claim 11 wherein the formation formed on the inner lid surface comprises a channel that contacts the top and at least two opposite sides of the plasma cutter and wherein the plasma cutter has projections formed thereon to engage the formation on the inner bottom surface of the protective case.

13. The combination of claim 11 wherein the aspect ratio of the chamber within the protective case is about the same as the aspect ratio of the plasma cutter.

14. The combination of claim 11 wherein the protective case has a second formation in the inner bottom surface to receive plug accessories.

15. The combination of claim 11 wherein the protective case has a third formation in the inner bottom surface to receive an accessory box located beneath the plasma cutter.

16. The combination of claim 11 wherein the plasma cutter further has at least two cables extending therefrom and the chamber is dimensioned to receive the cables.

17. The combination of claim 11 wherein the formation on the inner bottom surface comprises two spaced apart recesses and the plasma cutter has two projections that interfit into the spaced apart indentations.
